(19) United States
(12) Patent Application Publication
(10) Pub. No.: US 2024/0086373 A1
(43) Pub. Date: Mar. 14, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Hideto NOMIYAMA, Yokohama-shi (JP)

(73) Assignee: FUJIFILM Business Innovation Corp., Tokyo (JP)

(21) Appl. No.: 18/179,441

(22) Filed: Mar. 7, 2023

(30) Foreign Application Priority Data
Sep. 9, 2022 (JP) 2022-143954

(51) Int. Cl. G06F 16/18; G06F 16/176; G06F 21/62

(52) U.S. Cl. CPC G06F 16/1805; G06F 16/176; G06F 21/6209

(57) ABSTRACT

An information processing system includes one or more processors configured to: obtain one or more operation log records recorded in a collaboration service and information about one or more user attributes of corresponding users who use the collaboration service, the collaboration service supporting information sharing among multiple users; when the collaboration service identified from the content of one operation log record of the one or more operation log records involves multiple users, set an attribute condition on the basis of the information about one or more user attributes, the attribute condition indicating the scope of attributes of users who are allowed to refer to the one operation log record; and exert such control that, in response to an inquiry about reference to the one operation log record from an inquiry user who satisfies the attribute condition, the inquiry user is allowed to refer to the one operation log record.

### CROSS-REFERENCE TO RELATED APPLICATIONS

This application is based on and claims priority under 35 USC 119 from Japanese Patent Application No. 2022-143954 filed Sep. 9, 2022.

### BACKGROUND

### (i) Technical Field

The present disclosure relates to an information processing system, a non-transitory computer readable medium, and an information processing method.

### (ii) Related Art

In the field of so-called collaboration services which support sharing of information among multiple users, a known technique is such that a user operation log is recorded to enable ex-post determination as to whether a problem, such as an information leak or a compliance violation, has occurred (for example, Japanese Unexamined Patent Application Publication No. 2010-128901).

In such a technique, the scope of persons who are allowed to refer to an operation log record may be limited to a user who performed the operation, in order to ensure confidentiality of the operation log. However, collaboration services include services, such as a group chat, which need involvement of multiple users. Therefore, depending on the form of use of a collaboration service, separately referring to operation log records for each user may make it difficult to determine whether a problem, such as an information leak or a compliance violation, has occurred.

### SUMMARY

Aspects of non-limiting embodiments of the present disclosure relate to a technique in a collaboration service which supports sharing of information among multiple users. The technique allows reference to operation log records, each of which is recorded for the corresponding user, by each of users who have been involved in the operations, while the technique prevents reference to the operation log records by users who have not been involved in the operations.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: one or more processors configured to: obtain one or more operation log records recorded in a collaboration service and information about one or more user attributes of corresponding users who use the collaboration service, the collaboration service supporting information sharing among a plurality of users; when the collaboration service identified from content of one operation log record of the one or more operation log records involves a plurality of users, set an attribute condition on a basis of the information about one or more user attributes, the attribute condition indicating a scope of attributes of users who are allowed to refer to the one operation log record; and exert such control that, in response to an inquiry about reference to the one operation log record from an inquiry user who satisfies the attribute condition, the inquiry user is allowed to refer to the one operation log record.

### BRIEF DESCRIPTION OF THE DRAWINGS

Exemplary embodiments of the present disclosure will be described in detail based on the following figures, wherein:

FIG. 1 is a diagram illustrating an exemplary configuration of the entire information processing system to which the present exemplary embodiment is applied;

FIG. 2 is a diagram illustrating an exemplary hardware configuration of a log management server serving as an information processing apparatus to which the present exemplary embodiment is applied;

FIG. 3 is a diagram illustrating the functional configuration of a controller of a log management server;

FIG. 4 is a diagram illustrating the functional configuration of a controller of a user terminal;

FIG. 5 is a diagram illustrating the functional configuration of a controller of a key management server;

FIG. 6 is a flowchart of an exemplary partial process of a log management server until encryption of an operation log record;

FIG. 7 is a flowchart of an exemplary partial process of a user terminal until display of operation log records;

FIG. 8 is a flowchart of an exemplary process of a key management server;

FIG. 9 is a diagram illustrating a concrete example of user attribute information, which is stored in a database, of users who use a collaboration service;

FIG. 10 is a diagram illustrating a concrete example of relationship between “function” of a collaboration service, assumed “situation”, and “scope” of users who are allowed to refer to operation log records;

FIG. 11 is a diagram illustrating a concrete example of an attribute condition for each operation log record;

FIG. 12 is a diagram illustrating a concrete example of operations in a collaboration project in which the users in FIG. 9 participate;

FIG. 13 is a diagram illustrating a concrete example of operation log records in which operations in the collaboration project in FIG. 12 are recorded; and

FIG. 14 is a diagram illustrating a concrete example of operation log records to which some of the users in FIG. 9 are individually allowed to refer.

### DETAILED DESCRIPTION

An exemplary embodiment of the present disclosure will be described in detail below by referring to the attached drawings.

### The Configuration of an Information Processing System

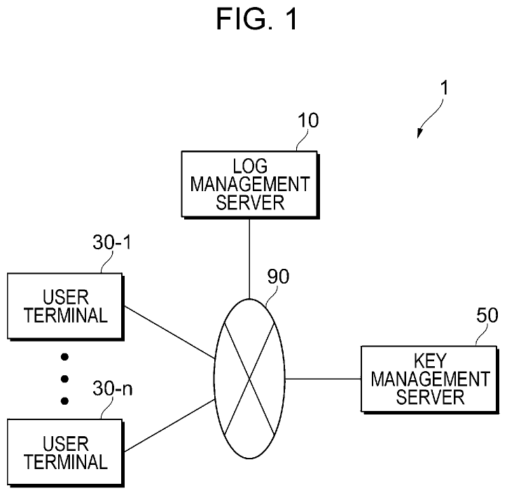

FIG. 1 is a diagram illustrating an exemplary configuration of the entire information processing system 1 to which the present exemplary embodiment is applied.

The information processing system 1 has a configuration in which a log management server 10, user terminals 30-1 to 30-n (n is an integer greater than or equal to two), and a key management server 50 are connected to each other through a network 90. The network 90 is, for example, a local area network (LAN) or the Internet. When the user terminals 30-1 to 30-n are not necessarily described individually, these are called user terminals 30 collectively. The log management server 10 is an information processing apparatus which serves as a server managing the entire information processing system 1. The log management server 10 also functions as a server managing a collaboration service provided to multiple users. In the present exemplary embodiment, the “collaboration service” refers to a service for implementing collaborative work in organizations to which multiple users belong. The collaboration service includes multiple services, such as a file storage service, a web meeting service, a mail service, a chat service, a task management service, and a schedule management service which use cloud computing.

The log management server 10 obtains operation log records, which are recorded in the collaboration service which supports sharing of information among multiple users, and information (hereinafter referred to as “user attribute information”) about attributes of users using the collaboration service. The user attribute information includes, for example, authentication information for use of the collaboration service, information about organizations to which the users belong, and information about the roles of the users.

When the service function, which is identified from the content of one of the operation log records recorded by the collaboration service, involves multiple users, the log management server 10 sets a condition (hereinafter referred to as an “attribute condition”) which defines the scope of the attributes of users who are allowed to refer to the operation log record. The attribute condition is set on the basis of the user attribute information. When a user who satisfies the attribute condition, which has been set, transmits an inquiry about reference of operation log records, the log management server 10 exerts control in response to the inquiry so that the user is allowed to refer to the operation log records.

The user terminals 30 are information processing apparatuses operated by users who are going to refer to the operation log recorded in the collaboration service. A user terminal 30 receives input of authentication information of a user. The authentication information, of which input is received by the user terminal 30, is transmitted as user attribute information to the key management server 50 which performs authentication. The user terminal 30 receives an inquiry for reference, which is performed by the user who has been authenticated, to the operation log, and transmits, to the key management server 50, information (hereinafter referred to as “inquiry information”) about the inquiry. After that, when decryption keys are transmitted from the key management server 50, the user terminal 30 decrypts operation log records by using the decryption keys for display on a display unit.

The key management server 50 is an information processing apparatus serving as a server which manages a key issuing service provided to multiple users. In the present exemplary embodiment, the “key issuing service” is a generic name of a service for generating an encryption key for encrypting an operation log record, and a service for generating a decryption key for decrypting an encrypted operation log record. An encryption key generated by the key management server 50 is transmitted to the log management server 10 which encrypts an operation log record. A decryption key generated by the key management server 50 is transmitted to a user terminal 30 which decrypts an encrypted operation log record.

The configuration of the information processing system 1 is exemplary. Any configuration may be employed as long as the entire information processing system 1 has functions for implementing the processes described above. Therefore, some or all of the functions for implementing the processes may be performed through sharing of the functions or through collaboration in the information processing system 1. That is, some or all of the functions of the log management server 10 may be performed as functions of each user terminal 30 or the key management server 50. Alternatively, some or all of the functions of each user terminal 30 may be performed as functions of the log management server 10 or the key management server 50. Alternatively, some or all of the functions of the key management server 50 may be performed as functions of the log management server 10 or each user terminal 30. Alternatively, some or all of the functions of each of the log management server 10, each user terminal 30, and the key management server 50 which are included in the information processing system 1 may be transferred to a different server (not illustrated). Thus, the process as the entire information processing system 1 may be accelerated, and the processes may complement each other.

### The Hardware Configuration of the Log Management Server

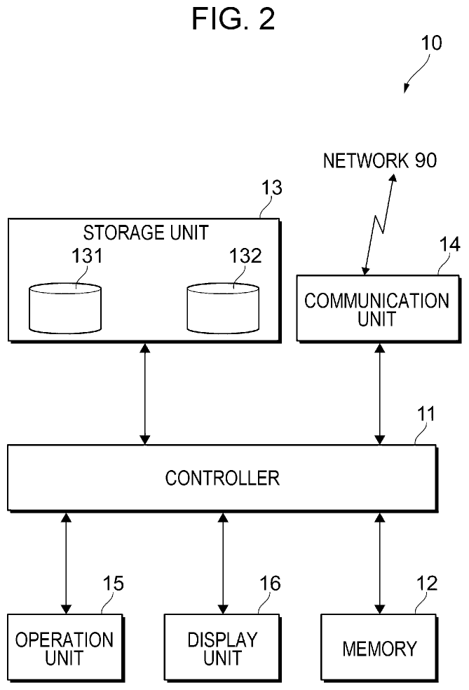

FIG. 2 is a diagram illustrating an exemplary hardware configuration of the log management server 10 serving as an information processing apparatus to which the present exemplary embodiment is applied.

The log management server 10 includes a controller 11, a memory 12, a storage unit 13, a communication unit 14, an operation unit 15, and a display unit 16. These units are connected to each other, for example, through a data bus, an address bus, and a peripheral component interconnect (PCI) bus.

The controller 11 is a processor which controls the functions of the log management server 10 through execution of various types of software, such as an operating system (OS), which is basic software, and application software. The controller 11 is formed, for example, of a central processing unit (CPU). The memory 12 is a storage area in which, for example, various types of software and data used in execution of the software are stored. The memory 12 is used as a work area in computation. The memory 12 is formed, for example, of a random access memory (RAM) and the like.

The storage unit 13 is a storage area in which, for example, input data to various types of software and output data from various types of software are stored. The storage unit 13 is formed, for example, of a hard disk drive (HDD), a solid state drive (SSD), or a semiconductor memory which is used, for example, to store programs and various types of setting data. The storage unit 13 stores, as databases which store various types of information, for example, a log DB 131, which stores operation log records, and a user DB 132, which stores the user attribute information.

The communication unit 14 receives/transmits data from/to the user terminals 30 and the outside through the network 90. The operation unit 15, which is formed, for example, of a keyboard, a mouse, mechanical buttons, and switches, receives input operations. The operation unit 15 encompasses a touch sensor forming a touch panel with the display unit 16 integrally. The display unit 16, which is formed, for example, of a liquid-crystal display or an organic light-emitting diode (OLED) display which is used to display information, displays image data and text data.

### The Hardware Configuration of the User Terminals and the Key Management Server

The hardware configuration of each of the user terminals 30 and the key management server 50 has substantially the same as that of the log management server 10 which is illustrated in FIG. 2. That is, each of the user terminals 30 and the key management server 50 includes a controller, a memory, a storage unit, a communication unit, an operation unit, and a display unit which have substantially the same functions as those of the controller 11, the memory 12, the storage unit 13, the communication unit 14, the operation unit 15, and the display unit 16 in FIG. 2. The configuration of each of the user terminals 30 and the key management server 50 will be neither illustrated nor described.

### The Functional Configuration of the Controller of the Log Management Server

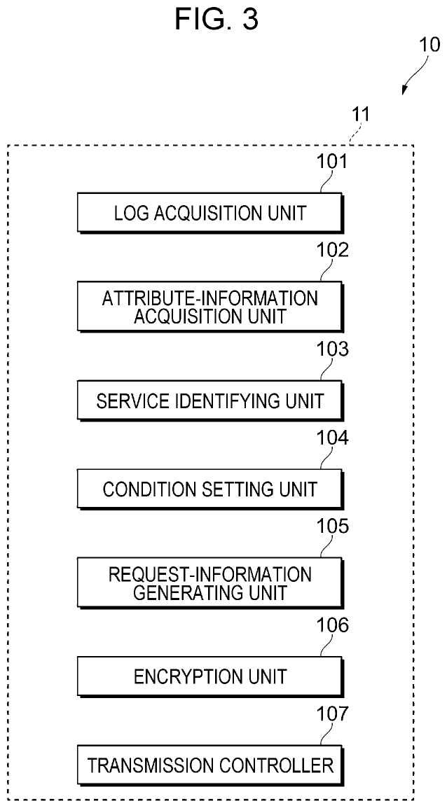

FIG. 3 is a diagram illustrating the functional configuration of the controller 11 of the log management server 10.

The controller 11 of the log management server 10 functions as a log acquisition unit 101, an attribute-information acquisition unit 102, a service identifying unit 103, a condition setting unit 104, a request-information generating unit 105, an encryption unit 106, and a transmission controller 107.

The log acquisition unit 101 acquires operation log records recorded in the collaboration service. The operation log records acquired by the log acquisition unit 101 are stored in the log DB 131 of the storage unit 13 (see FIG. 2) for management.

The attribute-information acquisition unit 102 acquires the user attribute information of users who use the collaboration service. Specifically, the attribute-information acquisition unit 102 acquires, through the communication unit 14 (see FIG. 2), the user attribute information transmitted from the user terminals 30. The user attribute information acquired by the attribute-information acquisition unit 102 is stored in the user DB 132 of the storage unit 13 for management.

On the basis of the content of an operation log record, the service identifying unit 103 identifies which service in the collaboration service the operation log record is related to. Specifically, on the basis of the content of an operation log record, the service identifying unit 103 identifies which service among services, such as a file storage service, a web meeting service, a mail service, a chat service, a task management service, and a schedule management service which use cloud computing, the operation log record is related to.

When the function of the service identified by the service identifying unit 103 involves multiple users, the condition setting unit 104 sets an attribute condition for the operation log record related to the service. The attribute condition is set on the basis of the user attribute information acquired by the attribute-information acquisition unit 102. Whether the function of a service involves multiple users is predetermined for each function of the collaboration service. For example, a file storage service, a web meeting service, a mail service, a chat service, and the like are determined to involve multiple users.

The request-information generating unit 105 generates information (hereinafter referred to as “request information”) for requesting, from the key management server 50, an encryption key for encrypting an operation log record. Specifically, the request information includes information for requesting generation of an encryption key associated with the attribute condition, which is set for each operation log record that is to be encrypted, and provision of the generated encryption key.

The encryption unit 106 obtains an encryption key generated by the key management server 50, and encrypts an operation log record by using the encryption key. The encryption allows only a user, who obtains a decryption key associated with the user attribute information satisfying the attribute condition which is set for the operation log record, to decrypt the operation log record for reference.

The transmission controller 107 controls transmission of various types of information to the log management server 10, the user terminals 30, and the outside. Specifically, for example, the transmission controller 107 transmits, to the key management server 50, request information generated by the request-information generating unit 105. In addition, the transmission controller 107 controls transmission of operation log records to a user terminal 30 which has made an access with decryption keys which enable decryption of the operation log records encrypted by using encryption keys.

### The Functional Configuration of the Controller of Each User Terminal

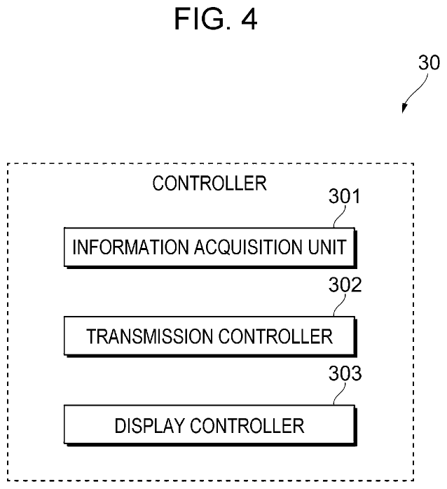

FIG. 4 is a diagram illustrating the functional configuration of the controller of each user terminal 30.

The controller of each user terminal 30 functions as an information acquisition unit 301, a transmission controller 302, and a display controller 303.

The information acquisition unit 301 acquires various types of information. For example, the information acquisition unit 301 acquires information which is input to the operation unit. Examples of the information which is input to the operation unit include authentication information, user attribute information, and inquiry information which are input by a user who is going to refer to the operation log of the collaboration service.

The information acquisition unit 301 acquires various types of information transmitted from the log management server 10, the key management server 50, and the outside. Specifically, for example, the information acquisition unit 301 acquires decryption keys which are used to decrypt encrypted operation log records and which are transmitted from the key management server 50. The decryption keys transmitted from the key management server 50 are associated with the user attribute information of the user who has transmitted an inquiry about the operation log.

The information acquisition unit 301 acquires operation log records transmitted from the log management server 10. Specifically, the information acquisition unit 301 accesses the operation log records which have been encrypted and managed by the log management server 10. The information acquisition unit 301 acquires the operation log records through decryption of the operation log records using decryption keys obtained from the key management server 50.

The transmission controller 302 controls transmission of various information to the log management server 10, the key management server 50, and the outside. Specifically, for example, the transmission controller 302 controls transmission of the user attribute information to the log management server 10. The transmission controller 302 controls transmission of inquiry information to the key management server 50.

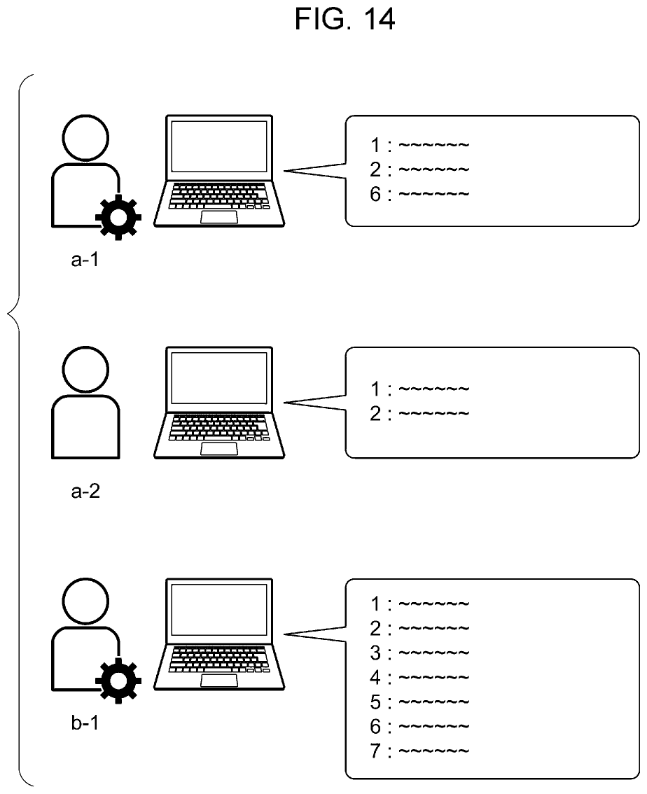

The display controller 303 controls display of various types of information on the display unit. Specifically, for example, the display controller 303 controls display of operation log records, which are transmitted from the log management server 10, on the display unit. A concrete example of operation log records displayed on the display unit through control of the display controller 303 will be described below by referring to FIG. 14.

### The Functional Configuration of the Controller of the Key Management Server

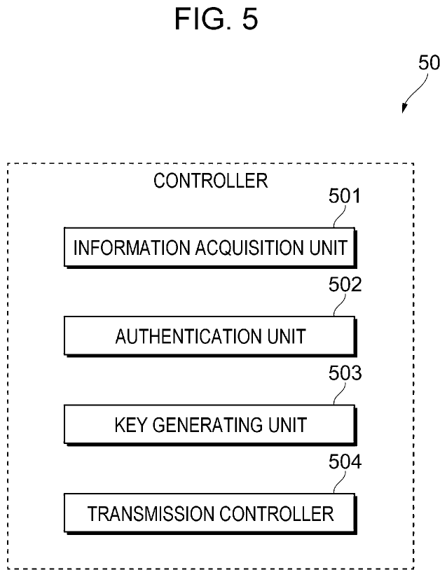

FIG. 5 is a diagram illustrating the functional configuration of the controller of the key management server 50.

The controller of the key management server 50 functions as an information acquisition unit 501, an authentication unit 502, a key generating unit 503, and a transmission controller 504.

The information acquisition unit 501 obtains various types of information transmitted from the log management server 10, the user terminals 30, and the outside. Specifically, for example, the information acquisition unit 501 acquires request information transmitted from the log management server 10. The information acquisition unit 501 acquires inquiry information transmitted from the user terminals 30.

The authentication unit 502 performs an operation of authentication of a user who has transmitted an inquiry for referring to the operation log. Specifically, the authentication unit 502 requests, from the log management server 10, authentication information of the user, who has transmitted the inquiry and who is identified from the inquiry information acquired by the information acquisition unit 501, and the attribute conditions of the operation log records the user wants to refer to.

When the authentication information of the user is transmitted from the log management server 10, the authentication unit 502 checks the authentication information against the authentication information of the user, which is included in the inquiry information obtained from the user terminal 30. Thus, the authentication unit 502 performs an operation of authentication of the user who has transmitted the inquiry. When the attribute conditions of the operation log records the user wants to refer to are transmitted from the log management server 10, the authentication unit 502 determines, for each of the attribute conditions of the operation log records, whether the user attribute information obtained from the user terminal 30 satisfies the attribute condition.

The key generating unit 503 generates an encryption key for encrypting an operation log record, and a decryption key for decrypting an encrypted operation log record. Specifically, the key generating unit 503 generates an encryption key associated with the attribute condition specified from request information acquired by the information acquisition unit 501.

The key generating unit 503 generates decryption keys associated with user attribute information, on the basis of a determination result obtained by the authentication unit 502. Specifically, for each encrypted operation log record, if the user attribute information of the user who has transmitted an inquiry satisfies the attribute condition which is set for the operation log record, the key generating unit 503 generates a decryption key. The user attribute information that is to be associated with a decryption key is specified from the inquiry information.

The transmission controller 504 controls transmission of various types of information to the log management server 10, the user terminals 30, and the outside. Specifically, for example, the transmission controller 504 controls transmission of an encryption key, which is associated with the attribute condition, to the log management server 10 which has transmitted request information. The transmission controller 504 controls transmission of decryption keys, which are associated with the user attribute information, to the user terminal 30 which has transmitted inquiry information.

### Process Flow of the Log Management Server

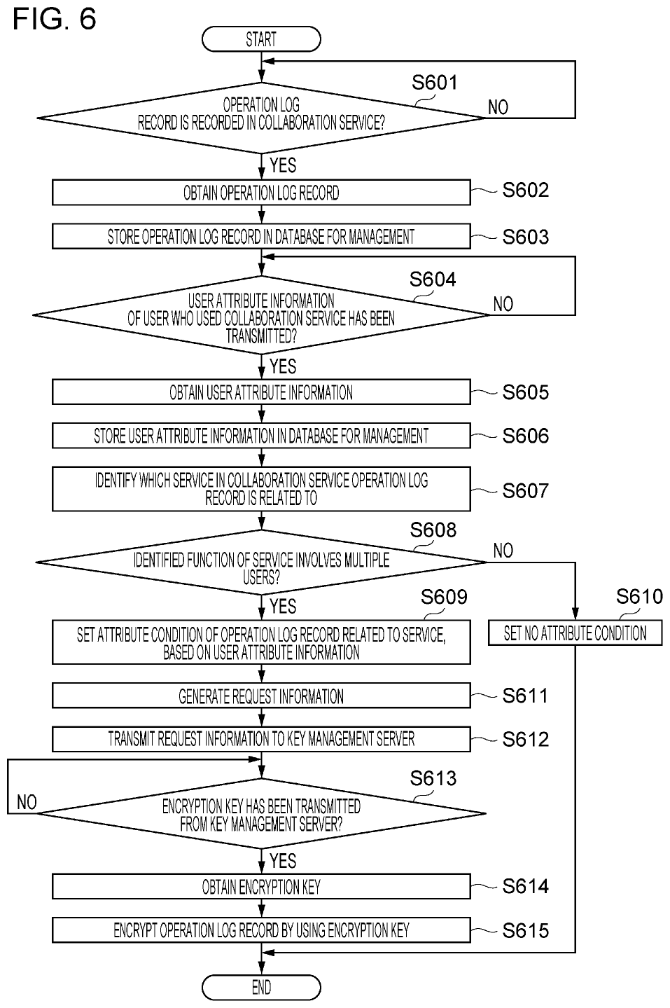

FIG. 6 is a flowchart of an exemplary partial process of the log management server 10 until encryption of an operation log record.

If an operation log record is recorded in the collaboration service (YES in step 601), the log management server 10 obtains the operation log record (step 602), and stores the operation log record in the database for management (step 603). In contrast, if an operation log record is not recorded in the collaboration service (NO in step 601), the log management server 10 repeatedly performs step 601 until an operation log record is recorded in the collaboration service.

If the user attribute information of the user who used the collaboration service has been transmitted from a user terminal 30 (YES in step 604), the log management server 10 obtains the user attribute information (step 605), and stores the user attribute information in the database for management (step 606). In contrast, if the user attribute information of the user has not been transmitted (NO in step 604), the log management server 10 repeatedly performs step 604 until the user attribute information of the user is transmitted.

The log management server 10 identifies which service in the collaboration service the operation log record obtained in step 602 is related to (step 607). If the function of the service identified in step 607 involves multiple users (YES in step 608), the log management server 10 sets an attribute condition of the operation log record related to the service, on the basis of the user attribute information obtained in step 605 (step 609). In contrast, if the function of the service identified in step 607 does not involve multiple users (NO in step 608), the log management server 10 does not set an attribute condition (step 610), and ends the process (END).

The log management server 10 generates request information (step 611), and transmits the request information to the key management server 50 (step 612). Request information to be transmitted includes information for requesting generation of an encryption key associated with the attribute condition, which is set for each operation log record that is to be encrypted, and provision of the generated encryption key.

If an encryption key has been transmitted from the key management server 50 (YES in step 613), the log management server 10 obtains the transmitted encryption key (step 614), and encrypts the operation log record by using the encryption key (step 615). Thus, the process ends (END). In contrast, if an encryption key has not been transmitted (NO in step 613), the log management server 10 repeatedly performs step 613 until an encryption key is transmitted.

### Process Flow of a User Terminal

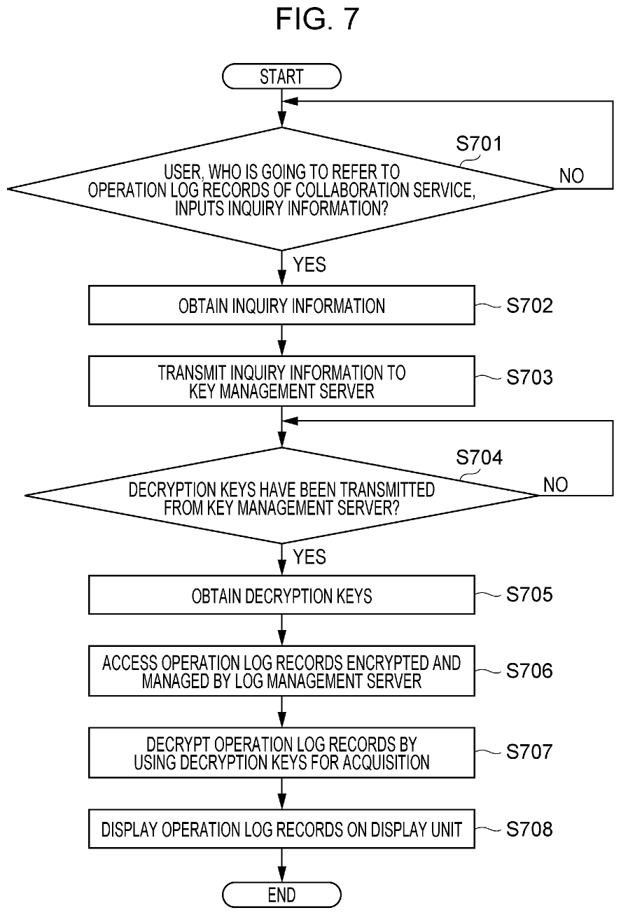

FIG. 7 is a flowchart of an exemplary partial process of a user terminal 30 until display of operation log records.

If a user, who is going to refer to the operation log of the collaboration service, inputs inquiry information (YES in step 701), the user terminal 30 obtains the inquiry information (step 702), and transmits the inquiry information to the key management server 50 (step 703). In contrast, if inquiry information has not been input (NO in step 701), the user terminal 30 repeatedly performs step 701 until inquiry information is input.

If decryption keys have been transmitted from the key management server 50 (YES in step 704), the user terminal 30 obtains the transmitted decryption keys (step 705). In contrast, if decryption keys have not been transmitted from the key management server 50 (NO in step 704), the user terminal 30 repeatedly performs step 704 until decryption keys are transmitted. Then, the user terminal 30 accesses the operation log records which have been encrypted and managed by the log management server 10 (step 706), and decrypts the operation log records by using the decryption keys obtained in step 705 for acquisition (step 707). Then, the user terminal 30 displays the obtained operation log records on the display unit (step 708).

### Process Flow of the Key Management Server

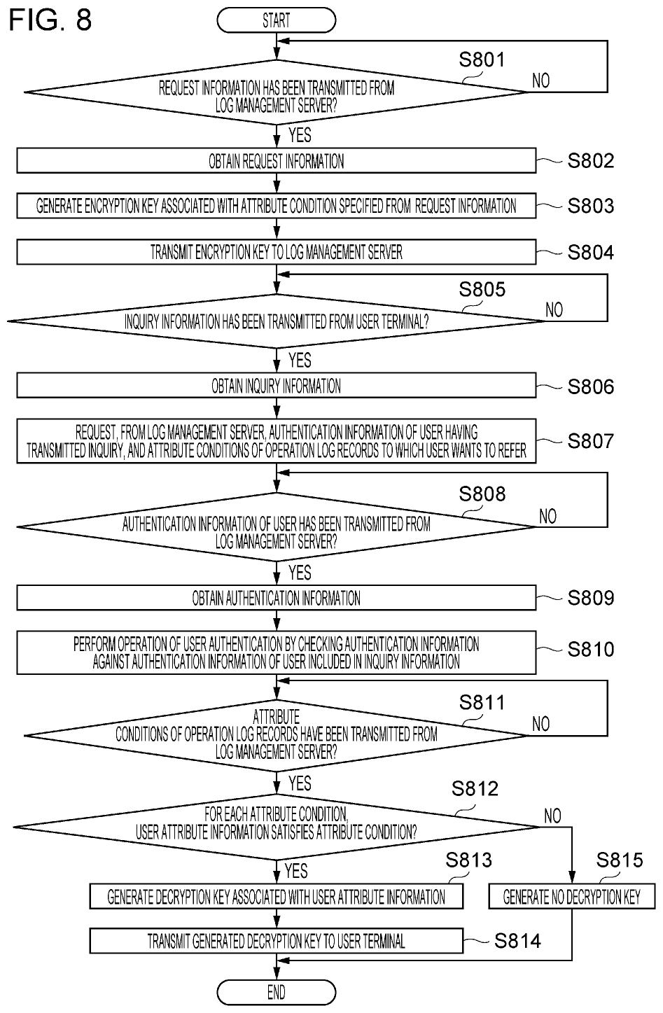

FIG. 8 is a flowchart of an exemplary process of the key management server 50.

If request information has been transmitted from the log management server 10 (YES in step 801), the key management server 50 obtains the transmitted request information (step 802), and generates an encryption key associated with the attribute condition specified from the request information (step 803). Then, the key management server 50 transmits the generated encryption key to the log management server 10 (step 804). In contrast, if request information has not been transmitted (NO in step 801), the key management server 50 repeatedly performs step 801 until request information is transmitted.

If inquiry information has been transmitted from a user terminal 30 (YES in step 805), the key management server 50 obtains the inquiry information (step 806). In contrast, if inquiry information has not been transmitted (NO in step 805), the key management server 50 repeatedly performs step 805 until inquiry information is transmitted. Then, on the basis of the inquiry information obtained in step 806, the key management server 50 requests, from the log management server 10, the authentication information of the user, who has transmitted the inquiry, and the attribute conditions of the operation log records the user wants to refer to (step 807).

If the authentication information of the user has been transmitted from the log management server 10 (YES in step 808), the key management server 50 obtains the transmitted authentication information (step 809), and performs an operation of user authentication by checking the transmitted authentication information against the authentication information of the user, which is included in the inquiry information (step 810). In contrast, if the authentication information of the user has not been transmitted from the log management server 10 (NO in step 808), the key management server 50 repeatedly performs step 808 until the authentication information of the user is transmitted from the log management server 10.

If the attribute conditions of the operation log records have been transmitted from the log management server 10 (YES in step 811), the key management server 50 determines, for each of the attribute conditions transmitted from the log management server 10, whether the user attribute information included in the inquiry information satisfies the attribute condition. In contrast, if the attribute conditions of the operation log records have not been transmitted from the log management server 10 (NO in step 811), the key management server 50 repeatedly performs step 811 until the attribute conditions of the operation log records are transmitted from the log management server 10.

For each of the attribute conditions, if the user attribute information satisfies the attribute condition (YES in step 812), the key management server 50 generates a decryption key associated with the user attribute information (step 813), and transmits the generated decryption key to the user terminal 30 (step 814). In contrast, if the user attribute information does not satisfy the attribute condition (NO in step 812), the key management server 50 does not generate a decryption key (step 815). Then, the key management server 50 ends the process (END).

### Concrete Examples

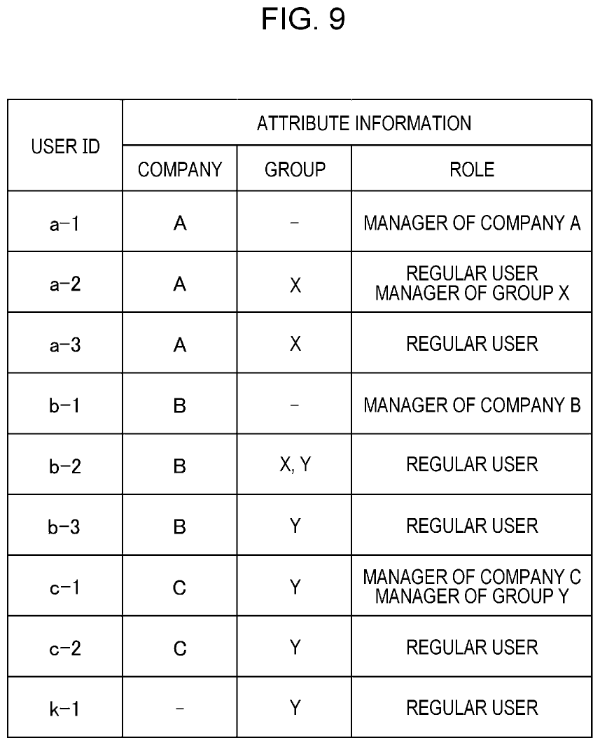

FIGS. 9 to 14 are diagrams illustrating concrete examples of the collaboration service to which the information processing system 1 in FIG. 1 is applied.

FIG. 9 illustrates a concrete example of user attribute information, which is stored in a database (for example, in the user DB 132 in FIG. 2), of users who use the collaboration service. As illustrated in FIG. 9, the user DB 132 stores associations between “user ID” which is identification information for uniquely identifying users, and “attribute information” indicating the user attribute information of the users. The “attribute information” includes “company”, “group”, and “role”. The “company” refers to a company to which a user belongs. The “group” refers to a group(s) in which a user participates. The group may be present across companies. The “role” refers to the role(s) of a user in their group and their company.

Specifically, a user whose “user ID” is “a-1” belongs to a “company” of “A”; does not belong to a “group”; and has a “role” of “manager of company A”. A user whose “user ID” is “a-2” belongs to the “company” of “A”; belongs to a “group” of “X”; has a “role” of “regular user” and a “role” of “manager of group X”. A user whose “user ID” is “a-3” belongs the “company” of “A”; belongs to the “group” of “X”; and has the “role” of “regular user”. A user whose “user ID” is “b-1” belongs to a “company” of “B”; does not belongs to a “group”; and has a “role” of “manager of company B”.

A user whose “user ID” is “b-2” belongs to the “company” of “B”: belongs to the “group” of “X” and a “group” of “Y”; and has the “role” of “regular user”. A user whose “user ID” is “b-3” belongs to the “company” of “B”; belongs to the “group” of “Y”; and has the “role” of “regular user”. A user whose “user ID” is “c-1” belongs to a “company” of “C”; belongs to the “group” of “Y”; and has a “role” of “manager of company C” and a “role” of “manager of group Y”. A user whose “user ID” is “c-2” belongs to the “company” of “C”; belongs to the “group” of “Y”; and has the “role” of “regular user”. A user whose “user ID” is “k-1” does not belong to a “company” (for example, a freelance); belongs to the “group” of “Y”; and has the “role” of “regular user”.

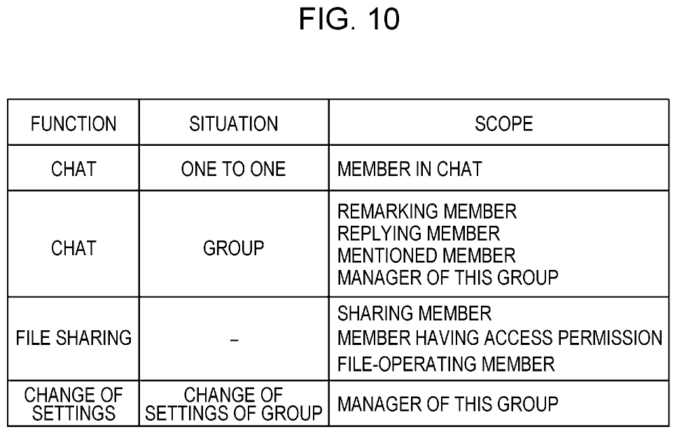

FIG. 10 illustrates a concrete example of the relationship between “function” of the collaboration service, assumed “situation”, and “scope” of users who are allowed to refer to operation log records. For example, “chat” as a “function” of the collaboration service means a chat service. The “situation” which is assumed in the chat service includes the case in which users use the service “one to one”, and the case in which users use the service in a “group”. When users use the service “one to one”, the “scope” of users who are allowed to refer to operation log records includes “member in chat”. When users use the service in a “group”, the “scope” of users who are allowed to refer to operation log records includes “remarking member”, “replying member”, “mentioned member”, and “manager of this group”.

In addition, “file sharing” as a “function” of the collaboration service means a file storage service using cloud computing. The “situation” which is assumed in the file storage service has no limitation. The “scope” of users who are allowed to refer to operation log records includes “sharing member” of a file, “member having access permission”, and “file-operating member”. In addition, “change of settings” as a “function” of the collaboration service means a service in which a user is allowed to change various setting values of the collaboration service. The “situation” which is assumed in the service is “change of settings of group”. In this case, the “scope” of users who are allowed to refer to operation log records includes “manager of this group”.

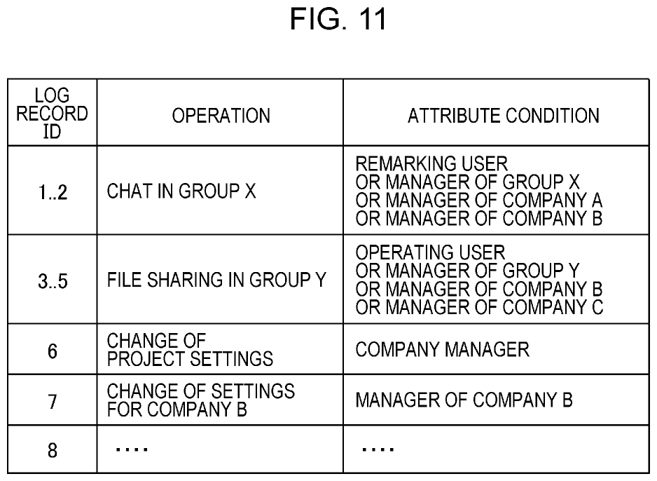

FIG. 11 illustrates a concrete example of the attribute conditions of the respective operation log records. The “log record ID” refers to identification information for uniquely identifying an operation log record; the “operation” refers to an operation recorded as an operation log record. For example, operation log records whose “log record IDs” are “1” and “2” (in FIG. 11, denoted as “1..2”) are records of operations of a chat service (chat in group X) used by the users who belong to the “group” of “X” in FIG. 9; the “attribute condition” is “remarking user OR manager of group X OR manager of company A OR manager of company B”. That is, a user who posted a remark by using “chat in group X”, a manager of “group X”, a manager of “company A”, and a manager of “company B” are allowed to refer to operation log records of “chat in group X”.

The operation log records whose “log record IDs” are “3” to “5” (in FIG. 11, denoted as “3..5”) are records of operations of a file storage service (file sharing in group Y) used by the users who belong to the “group” of “Y” in FIG. 9; the “attribute condition” is “operating user OR manager of group Y OR manager of company B OR manager of company C”. That is, users who used “file sharing in group Y”, a manager of “group Y”, a manager of “company B”, and a manager of “company C” are allowed to refer to operation log records of “file sharing in group Y”.

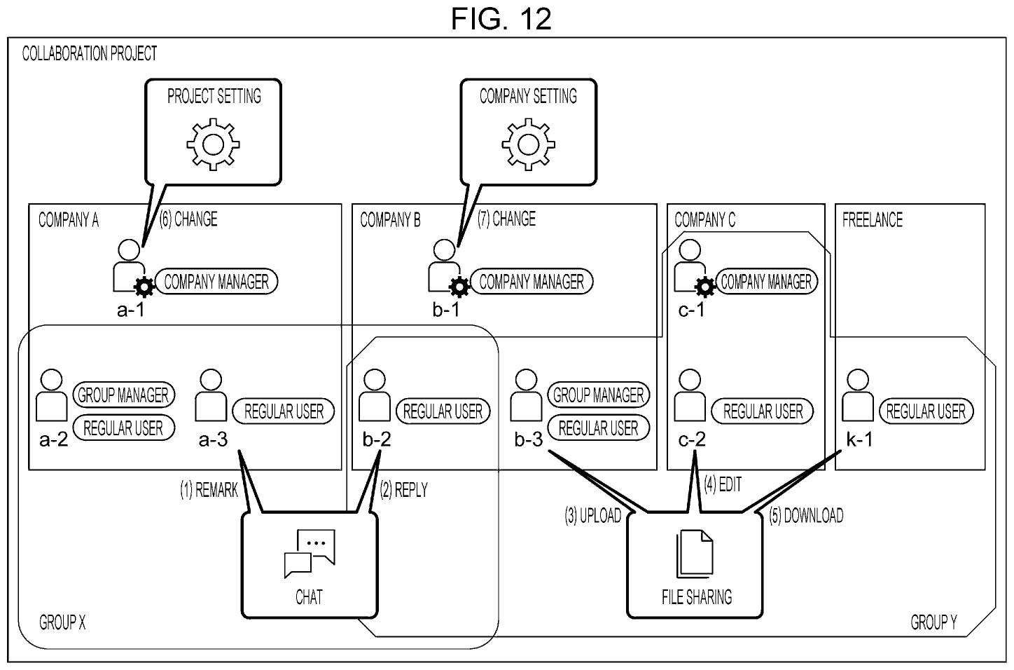

An operation log record whose “log record ID” is “6” is a record of an operation of changing project settings in the collaboration service. The “attribute condition” of the operation log record whose “log record ID” is “6” is “company manager”. That is, a manager of “company A”, a manager of “company B”, and a manager of “company C” are allowed to refer to operation log records of “change of project settings” in the collaboration service. A project (hereinafter referred to as a “collaboration project”) in the collaboration service is a collaborative project in which multiple groups, companies, and users participate. A concrete example of a collaboration project will be described below by referring to FIG. 12 which is described below.

An operation log record whose “log record ID” is “7” is a record of an operation of changing settings of company B; the “attribute condition” is “manager of company B”. That is, a manager of “company B” is allowed to refer to operation log records of “change of settings for company B” in the collaboration service.

FIG. 12 illustrates a concrete example of operations in a collaboration project in which the multiple users in FIG. 9 participate.

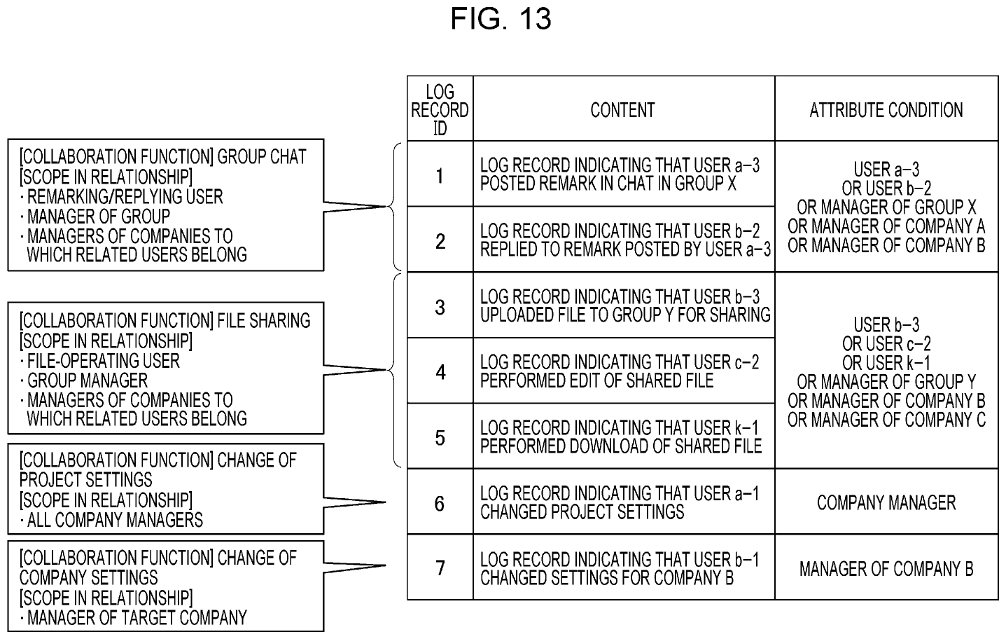

FIG. 13 illustrates a concrete example of operation log records in which operations in the collaboration project in FIG. 12 are recorded.

As illustrated in FIG. 12, in a chat service (chat in group X) used by a user whose “user ID” is “a-3” and a user whose “user ID” is “b-2”, when the user whose “user ID” is “a-3” posts a “remark” as operation (1), an operation log record is recorded in the log DB 131 (see FIG. 2). Specifically, as illustrated in FIG. 13, an operation log record, whose “content” is “log record indicating that user a-3 posted remark in chat in group X” and whose “attribute condition” is “user a-3 OR user b-2 OR manager of group X OR manager of company A OR manager of company B”, is recorded as an operation log record whose “log record ID” is “1”.

Back to FIG. 12, in the chat service (chat in group X), when, as operation (2), the user whose “user ID” is “b-2” posted a “reply” to the remark posted by the user whose “user ID” is “a-3”, an operation log record is recorded in the log DB 131. Specifically, as illustrated in FIG. 13, an operation log record, whose “content” is “log record indicating that user b-2 replied to remark posted by user a-3” and whose “attribute condition” is “user a-3 OR user b-2 OR manager of group X OR manager of company A OR manager of company B”, is recorded as an operation log record whose “log record ID” is “2”.

As illustrated in FIG. 13, the operation log records whose “log record IDs” are “1” and “2” indicate operations in use of group chat as a function (collaboration function) of the collaboration service. The scope (scope in relationship) of users involved in the operations includes a user who posted a remark, a user who posted a reply, a manager of the group, a manager of the company to which the user who posted a remark belong, and a manager of the company to which the user who posted a reply belong.

Back to FIG. 12, in a file storage service (file sharing) used by the user whose “user ID” is “b-3”, the user whose “user ID” is “c-2”, and the user whose “user ID” is “k-1”, when the user whose “user ID” is “b-3” performs “upload” as operation (3), an operation log record is recorded in the log DB 131. Specifically, as illustrated in FIG. 13, an operation log record, whose “content” is “log record indicating that user b-3 uploaded file to group Y for sharing” and whose “attribute condition” is “user b-3 OR user c-2 OR user k-1 OR manager of group Y OR manager of company B OR manager of company C”, is recorded as an operation log record whose “log record ID” is “3”.

Back to FIG. 12, when the user whose “user ID” is “c-2” performs “edit” as operation (4), an operation log record is recorded in the log DB 131. Specifically, as illustrated in FIG. 13, an operation log, whose “content” is “log record indicating that user c-2 performed edit of shared file” and whose “attribute condition” is “user b-3 OR user c-2 OR user k-1 OR manager of group Y OR manager of company B OR manager of company C”, is recorded as an operation log record whose “log record ID” is “4”.

Back to FIG. 12, when the user whose “user ID” is “k-1” performs “download” as operation (5), an operation log record is recorded in the log DB 131. Specifically, as illustrated in FIG. 13, an operation log record, whose “content” is “log record indicating that user k-1 performed download of shared file” and whose “attribute condition” is “user b-3 OR user c-2 OR user k-1 OR manager of group Y OR manager of company B OR manager of company C”, is recorded as an operation log record whose “log record ID” is “5”.

As illustrated in FIG. 13, the operation log records whose “log record IDs” are “3” to “5” indicate operations in use of file storage service (file sharing) as a function (collaboration function) of the collaboration service. The scope (scope in relationship) of users involved in the operations includes users who operated a file, a manager of the group, and managers of the companies to which the users who operated the file belong.

Back to FIG. 12, when the user whose “user ID” is “a-1” performs “change” as operation (6), an operation log record is recorded in the log DB 131. Specifically, as illustrated in FIG. 13, an operation log record, whose “content” is “log record indicating that user a-1 changed project settings” and whose “attribute condition” is “company manager”, is recorded as an operation log record whose “log record ID” is “6”. As illustrated in FIG. 13, the operation log record whose “log record ID” is “6” indicates an operation in change of project settings as a function (collaboration function) of the collaboration service. The scope (scope in relationship) of users involved in the operation includes all company managers.

Back to FIG. 12, when the user whose “user ID” is “b-1” performs “change” as operation (7), an operation log record is recorded in the log DB 131. Specifically, as illustrated in FIG. 13, an operation log record, whose “content” is “log record indicating that user b-1 changed settings for company B” and whose “attribute condition” is “manager of company B”, is recorded as an operation log record whose “log record ID” is “7”. As illustrated in FIG. 13, the operation log record whose “log record ID” is “7” indicates an operation in change of company settings as a function (collaboration function) of the collaboration service. The scope (scope in relationship) of users involved in an operation includes a manager of company B (target-company manager).

FIG. 14 illustrates concrete examples of operation log records to which some of the users in FIG. 9 are individually allowed to refer. The numerals of “1” to “7” illustrated in FIG. 14 correspond to the numerals of “log record ID” in FIG. 13. That is, the user whose “user ID” is “a-1” is allowed to refer to the operation log records whose “log record IDs” are “1”, “2”, and “6”. The user whose “user ID” is “a-2” is allowed to refer to the operation log records whose “log record IDs” are “1” and “2”. The user whose “user ID” is “b-1” is allowed to refer to operation log records whose “log record IDs” are “1” to “7”.

Thus, for example, the user whose “user ID” is “a-1” and the user whose “user ID” is “a-2” belong to the same company, while these users and the user whose “user ID” is “b-1” belong to different companies. However, the user attribute information of these three users satisfies the attribute conditions of the operation log records whose “log record IDs” are “1” and “2”. Therefore, these three users are allowed to refer to the operation log records whose “log record IDs” are “1” and “2”.

For example, the user whose “user ID” is “a-1” and the user whose “user ID” is “b-1” belong to different companies. However, the companies have a collaborative relationship in the same collaboration project. In addition, the two users are company managers. Therefore, the user attribute information of these two users satisfies the attribute condition of the operation log record whose “log record ID” is “6”. As a result, these two users are allowed to refer to the operation log whose “log record ID” is “6”.

### Other Exemplary Embodiments

The present exemplary embodiment is described above. However, the present disclosure is not limited to the present exemplary embodiment. The effects of the present disclosure are not limited to those described in the present exemplary embodiment. For example, the configuration of the information processing system 1 which is illustrated in FIG. 1, and the hardware configuration of the log management server 10 which is illustrated in FIG. 2 are merely exemplary to attain the object of the present disclosure, and are not particularly limited. The functional configuration of the log management server 10 which is illustrated in FIG. 3, the functional configuration of a user terminal 30 which is illustrated in FIG. 4, and the functional configuration of the key management server 50 which is illustrated in FIG. 5 are also merely exemplary, and are not particularly limited. Any configuration may be employed as long as the information processing system 1 in FIG. 1 includes a function of performing the processes, as a whole, described above. Functional configurations employed to implement the function are not limited to the examples in FIGS. 3 to 5.

The order of steps in the process illustrated in FIG. 6 and performed by the log management server 10, the order of steps in the process illustrated in FIG. 7 and performed by a user terminal 30, and the order of steps in the process illustrated in FIG. 8 and performed by the key management server 50 are also merely exemplary, and are not particularly limited. Not only is a process performed chronologically in the illustrated order of steps, but the process is not necessarily processed chronologically, and the process may be performed in parallel or individually. The concrete examples in FIGS. 9 to 14 are also merely exemplary, and are not particularly limited.

For example, in the exemplary embodiment described above, the key management server 50 performs an operation of user authentication. However, the configuration is not limited to this. For example, the log management server 10 or an external server may perform an operation of user authentication.

In the exemplary embodiment, control to cause an operation log record not to be allowed to be referred to is exerted through encryption using an encryption key; control to cause operation log records to be allowed to be referred to is exerted through decryption using decryption keys. However, the configuration is not limited to this. Another method other than a combination of an encryption key and a decryption key may be used to conceal an operation log record and cancel the concealment of the operation log record.

In the exemplary embodiment, the example in which user attribute information is not changed is described. The user attribute information may be changed in accordance with a user's retirement, job change, personal change, promotion, or the like. In this case, a user may input, on a user terminal 30 (see FIG. 1), a change of the user information. Thus, the user attribute information recorded in the user DB 132 stored in the storage unit 13 (see FIG. 2) of the log management server 10 (see FIG. 1) may be updated.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   obtain one or more operation log records recorded in a collaboration service and information about one or more user attributes of corresponding users who use the collaboration service, the collaboration service supporting information sharing among a plurality of users;
   when the collaboration service identified from content of one operation log record of the one or more operation log records involves a plurality of users, set an attribute condition on a basis of the information about one or more user attributes, the attribute condition indicating a scope of attributes of users who are allowed to refer to the one operation log record; and
   exert such control that, in response to an inquiry about reference to the one operation log record from an inquiry user who satisfies the attribute condition, the inquiry user is allowed to refer to the one operation log record.
      (((2)))

The information processing system according to (((1))),
wherein, for each function of the collaboration service, whether the function involves a plurality of users is predetermined.
   (((3)))

The information processing system according to (((2))),
wherein the attribute condition is predetermined for each function of the collaboration service.
   (((4)))

The information processing system according to (((1))),
wherein the one or more processors are configured to:
   specify the attribute of the inquiry user from the obtained information about one or more user attributes, the inquiry user having transmitted the inquiry, and thus determine whether the attribute of the inquiry user satisfies the attribute condition.
      (((5)))

The information processing system according to (((4))),
wherein the attribute condition includes a combination of an organization to which the inquiry user belongs and a role of the inquiry user, the combination being described as the attribute of the inquiry user.
   (((6)))

The information processing system according to (((5))),
wherein the one or more processors are configured to:
   set, for the one operation log record, the attribute condition including one or more types of the combination.
      (((7)))

The information processing system according to (((5))) or (((6))),
wherein the organization, in the attribute of the inquiry user, to which the inquiry user belongs includes any of a plurality of organizations operated or managed by different agencies.
   (((8)))

The information processing system according to any one of (((5))) to (((7))),
wherein the one or more processors are configured to:
   for each operation log record, generate an encryption key associated with the attribute condition, as an encryption key for encrypting the operation log record; and
   exert such control that the encryption key is used to encrypt the one operation log record.
      (((9)))

The information processing system according to (((8))),
wherein the one or more processors are configured to:
   as such control that, in response to the inquiry user's inquiry about reference to the one operation log record, the inquiry user is allowed to refer to the one operation log record,
   exert such control that a decryption key is generated as a decryption key for decrypting the one operation log which has been encrypted by using the encryption key, and is provided to the inquiry user, the decryption key being associated with the inquiry user's attribute satisfying the attribute condition.
      (((10)))

A program causing a computer to execute a process comprising:
obtaining one or more operation log records recorded in a collaboration service and information about one or more user attributes of corresponding users who use the collaboration service, the collaboration service supporting information sharing among a plurality of users;
when the collaboration service identified from content of one operation log record of the one or more operation log records involves a plurality of users, setting an attribute condition on a basis of the information about one or more user attributes, the attribute condition indicating a scope of attributes of users who are allowed to refer to the one operation log record; and
exerting such control that, in response to an inquiry about reference to the one operation log record from an inquiry user who satisfies the attribute condition, the inquiry user is allowed to refer to the one operation log record.

What is claimed is:

1. An information processing system comprising:
one or more processors configured to:
obtain one or more operation log records recorded in a collaboration service and information about one or more user attributes of corresponding users who use the collaboration service, the collaboration service supporting information sharing among a plurality of users;
when the collaboration service identified from content of one operation log record of the one or more operation log records involves a plurality of users, set an attribute condition on a basis of the information about one or more user attributes, the attribute condition indicating a scope of attributes of users who are allowed to refer to the one operation log record; and
exert such control that, in response to an inquiry about reference to the one operation log record from an inquiry user who satisfies the attribute condition, the inquiry user is allowed to refer to the one operation log record.

2. The information processing system according to claim 1,
wherein, for each function of the collaboration service, whether the function involves a plurality of users is predetermined.

3. The information processing system according to claim 2,
wherein the attribute condition is predetermined for each function of the collaboration service.

4. The information processing system according to claim 1,
wherein the one or more processors are configured to:
specify the attribute of the inquiry user from the obtained information about one or more user attributes, the inquiry user having transmitted the inquiry, and thus determine whether the attribute of the inquiry user satisfies the attribute condition.

5. The information processing system according to claim 4,
wherein the attribute condition includes a combination of an organization to which the inquiry user belongs and a role of the inquiry user, the combination being described as the attribute of the inquiry user.

6. The information processing system according to claim 5,
wherein the one or more processors are configured to:
set, for the one operation log record, the attribute condition including one or more types of the combination.

7. The information processing system according to claim 6,
wherein the organization, in the attribute of the inquiry user, to which the inquiry user belongs includes any of a plurality of organizations operated or managed by different agencies.

8. The information processing system according to claim 7,
wherein the one or more processors are configured to:
for each operation log record, generate an encryption key associated with the attribute condition, as an encryption key for encrypting the operation log record; and
exert such control that the encryption key is used to encrypt the one operation log record.

9. The information processing system according to claim 8,
wherein the one or more processors are configured to:
as such control that, in response to the inquiry user's inquiry about reference to the one operation log record, the inquiry user is allowed to refer to the one operation log record,
exert such control that a decryption key is generated as a decryption key for decrypting the one operation log which has been encrypted by using the encryption key, and is provided to the inquiry user, the decryption key being associated with the inquiry user's attribute satisfying the attribute condition.

10. A non-transitory computer readable medium storing a program causing a computer to execute a process comprising:
obtaining one or more operation log records recorded in a collaboration service and information about one or more user attributes of corresponding users who use the collaboration service, the collaboration service supporting information sharing among a plurality of users;
when the collaboration service identified from content of one operation log record of the one or more operation log records involves a plurality of users, setting an attribute condition on a basis of the information about one or more user attributes, the attribute condition indicating a scope of attributes of users who are allowed to refer to the one operation log record; and
exerting such control that, in response to an inquiry about reference to the one operation log record from an inquiry user who satisfies the attribute condition, the inquiry user is allowed to refer to the one operation log record.

11. An information processing method comprising:
obtaining one or more operation log records recorded in a collaboration service and information about one or more user attributes of corresponding users who use the collaboration service, the collaboration service supporting information sharing among a plurality of users;
when the collaboration service identified from content of one operation log record of the one or more operation log records involves a plurality of users, setting an attribute condition on a basis of the information about one or more user attributes, the attribute condition indicating a scope of attributes of users who are allowed to refer to the one operation log record; and
exerting such control that, in response to an inquiry about reference to the one operation log record from an inquiry user who satisfies the attribute condition, the inquiry user is allowed to refer to the one operation log record.
